(19) United States
(12) Patent Application Publication
(10) Pub. No.: US 2025/0328091 A1
(43) Pub. Date: Oct. 23, 2025

(54) IMAGE FORMING APPARATUS

(71) Applicant: CANON KABUSHIKI KAISHA, Tokyo (JP)

(72) Inventors: Yusuke Shimizu, Kanagawa (JP); Hikaru Osada, Kanagawa (JP); Akisato Sakaki, Kanagawa (JP); Jun Hara, Kanagawa (JP); Isamu Takeda, Tokyo (JP); Shinsuke Kobayashi, Kanagawa (JP)

(21) Appl. No.: 19/098,247

(22) Filed: Apr. 2, 2025

(30) Foreign Application Priority Data
Apr. 23, 2024 (JP) 2024-070172

(51) Int. Cl. G03G 15/01

(52) U.S. Cl. CPC G03G 15/0121; G03G 15/0173

(57) ABSTRACT

An image forming apparatus includes an image bearing member, a rotary including a developing chamber and a developing member, and a toner cartridge. The developing chamber includes a partition wall for partitioning the developing chamber into a first region including the developing member and a second region. The toner is supplied from the toner cartridge to the developing chamber by communication between a receiving opening provided in the developing chamber and a discharge opening provided in the toner cartridge. The toner accommodated in the toner cartridge and the toner accommodated in the first region are moved to the second region by rotation of the rotary and then are mixed in the second region.

### FIELD OF THE INVENTION AND RELATED ART

The present invention relates to an image forming apparatus, such as a printer, a copying machine, a facsimile machine, or a multi-function machine having a plurality of functions of functions of these machines, using an electrophotographic type.

Conventionally, in the image forming apparatus of the electrophotographic type, a rotary development type in which an electrostatic latent image on a surface of a photosensitive member is developed with toner of different colors by rotating a rotary including a plurality of developing chambers each provided with a developing roller has been known.

In Japanese Laid-Open Patent Application No. 2007-188305, an image forming apparatus including a rotary provided with a plurality of developing devices (developing chambers), and a plurality of toner cartridges (toner accommodating containers) detachably mountable to the rotary.

### SUMMARY OF THE INVENTION

The toner in the developing chamber is carried on the developing roller and is subjected to a mechanical stress by being rubbed with a developing blade, the photosensitive member, or the like, so that the toner is gradually deteriorated. There is a tendency that deterioration of the toner progresses and thus the toner deformed from an original particle shape and the toner of which external additive is peeled off and dropped from a particle surface thereof lower in triboelectric charging performance.

When new toner is supplied from the toner cartridge to the developing chamber, between the deteriorated toner damaged in the developing chamber and the new toner, there arises a difference in triboelectric charging performance (triboelectric charging power).

There is a tendency that the deteriorated toner is not readily charged to a normal charge polarity and the new toner is readily charged. For that reason, immediately after the deteriorated toner low in triboelectric charging performance is mixed with the new toner, an electric charge of the deteriorated toner is liable to become a low state. When the toner in this state is coated on the developing roller, a phenomenon called a “fog” such that the toner is placed on a non-image forming portion of the photosensitive member occurs in some instances. Such a fog due to the supply of the toner to the developing chamber is referred to as a “supply fog”.

Therefore, a principal object of the present invention is to suppress an occurrence of the supply fog in a constitution in which the toner cartridge in which toner supplied to the developing chamber s accommodated is detachably mountable to the rotatable rotary including the plurality of the developing chambers.

The object is accomplished by an image forming apparatus according to the present invention.

According to an aspect of the present invention, there is provided an image forming apparatus comprising: an image bearing member on which an electrostatic image is formed; a rotary including a developing chamber for accommodating toner and a developing member for developing the electrostatic image by supplying the toner accommodated in the developing chamber to the image bearing member and rotatable so as to move the developing member to a developing position where the developing member supplies the toner to the image bearing member; and a toner cartridge configured to accommodate the toner supplied to the developing chamber and detachably mounted to the rotary, wherein the developing chamber includes a partition wall for partitioning the developing chamber into a first region including the developing member and a second region, wherein the toner is supplied from the toner cartridge to the developing chamber by communication between a receiving opening provided in the developing chamber and a discharge opening provided in the toner cartridge; and wherein the toner accommodated in the toner cartridge and the toner accommodated in the first region are moved to the second region by rotation of the rotary and then are mixed in the second region.

Further features of the present invention will become apparent from the following description of exemplary embodiments with reference to the attached drawings.

### BRIEF DESCRIPTION OF THE DRAWINGS

FIG. 1 is a schematic sectional view of an image forming apparatus.

FIG. 2 is a schematic sectional view of a developing unit in an embodiment 1.

FIG. 3 is a schematic sectional view of the developing unit.

FIG. 4 is a schematic sectional view of the developing unit for illustrating an example of a toner surface (developer surface) in a developing chamber.

FIG. 5 is a schematic sectional view of the developing unit for illustrating another example of the toner surface in the developing chamber.

FIG. 6 is a schematic sectional view of a developing unit in a comparison example.

Part (a) to (g) of FIG. 7 are schematic sectional views of a rotary developing device for illustrating a toner mixing mechanism in the embodiment 1.

Parts (a) to (h) of FIG. 8 are schematic sectional views of the rotary developing device for illustrating the toner mixing mechanism in the embodiment 1.

FIG. 9 is a schematic sectional view of the developing unit for illustrating another example of the toner surface in the developing chamber.

FIG. 10 is a schematic sectional view of another example of the developing voltage.

Parts (a) to (g) of FIG. 11 are schematic sectional views of a rotary developing device for illustrating a toner mixing mechanism in an embodiment 2.

Parts (a) to (h) of FIG. 12 are schematic sectional views of the rotary developing unit for illustrating the toner mixing mechanism in the embodiment 2.

Parts (a) and (b) of FIG. 13 are a schematic sectional view of a developing unit and a schematic front view of an inner wall of a developing chamber, respectively, for illustrating another example of the developing unit.

### DESCRIPTION OF THE EMBODIMENTS

In the following, an image forming apparatus according to the present invention will be described with reference to the drawings.

### Embodiment 1

### 1. General Constitution of Image Forming Apparatus

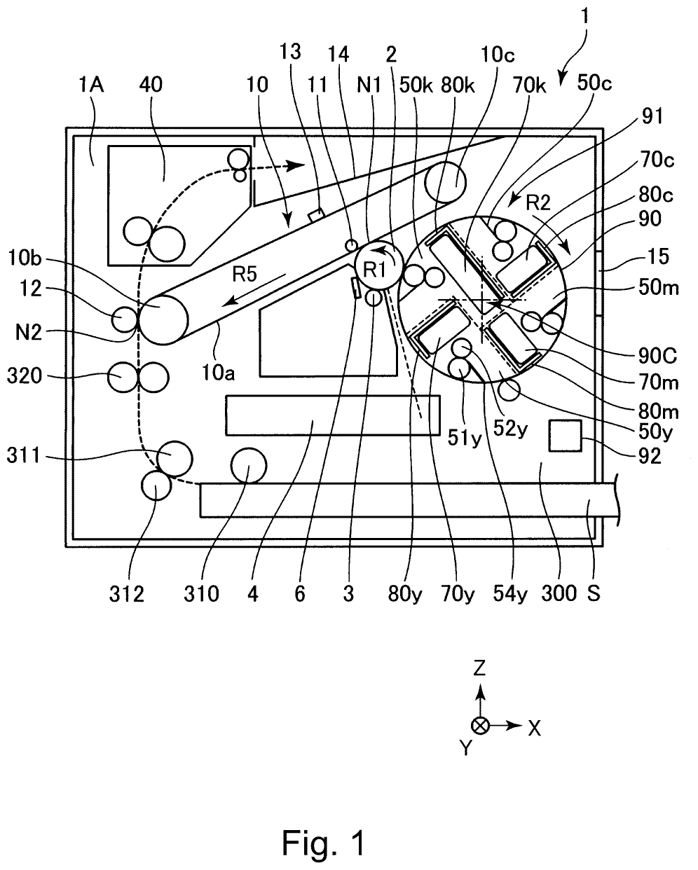

First, a general constitution of an image forming apparatus 1. FIG. 1 is a schematic sectional view of the image forming apparatus 1 of this embodiment. The image forming apparatus 1 of this embodiment is a laser beam printer for forming an image on a sheet S by an electrophotographic type. Specifically, the image forming apparatus 1 of this embodiment is a color laser beam printer including four developing units 50y, 50m, 50c, and 50k in a rotatable rotary 90.

Incidentally, as the sheet S which is a recording material (recording medium transfer material), various sheet materials, different in size and material, including paper such as plain paper or thick paper, a plastic film, cloth, a surface-treated sheet material such as coated paper, a special-shaped sheet material such as an envelope or index paper are usable.

Further, as regards the image forming apparatus 1 and elements thereof, a vertical direction (direction of gravitation) in the case where the image forming apparatus 1 is installed on a horizontal surface is referred to as a “Z direction”. Further, a direction (rotational axis direction of the rotary 90) crossing (in this embodiment, perpendicular to) the Z direction and parallel to a rotational axis 90C of the rotary 90 is referred to as a “Y direction”. A direction crossing (in this embodiment, perpendicular to) both the Z direction and the Y direction is referred to as an “X direction”. In the case where the image forming apparatus 1 is installed on the horizontal surface, the X direction and the Y direction are a horizontal direction. Further, as regards the image forming apparatus 1 and the elements thereof, “up (above)” and “down (below)” refer to those with respect to the vertical direction (direction of gravitation), but do not mean “immediately above (on)” and “immediately below (under)”, and include an “upper side” and a “lower surface” of the horizontal surface passing through an associated one of the elements or a position thereof.

As shown in FIG. 1, the image forming apparatus 1 includes an image forming apparatus main assembly (hereinafter, simply referred to as an “apparatus main assembly”) 1A and toner cartridges 70y, 70m, 70c, and 70k detachably mountable to the apparatus main assembly 1A (rotary 90).

The apparatus main assembly 1A includes a photosensitive drum 2 which is an electrophotographic photosensitive member (photosensitive member), having a drum shape (cylindrical shape), as an image bearing member for bearing an electrostatic latent image or a toner image. The photosensitive drum 2 is rotatably supported by a frame or the like constituting the apparatus main assembly 1A. At a periphery of the photosensitive drum 2, a charging roller 3, a scanner 4 which is an exposure device, a rotary developing device 91 including the four developing units 50y, 50m, 50c, and 50k, and a cleaning unit 6 are provided.

The charging roller 3 is an example of a charging means for electrically charging a surface of the photosensitive drum 2 uniformly. The charging roller 3 is constituted by a roller-shaped charging member disposed in contact with the surface (outer peripheral surface) of the photosensitive drum 2. The scanner 4 is an example of an exposure means for exposing the surface of the photosensitive drum 2 to laser light depending on image information. The scanner 4 forms the electrostatic latent image (electrostatic image) on the surface of the photosensitive drum 2 by irradiating the charged surface of the photosensitive drum 2 with the laser light. The cleaning unit 6 is an example of a cleaning means for removing toner remaining on the surface of the photosensitive drum 2.

The rotary developing device 91 includes the rotary (rotary main body) 90 provided with the developing units 50y, 50m, 50c, and 50k. The rotary 90 is rotatably supported by the frame or the like constituting the apparatus main assembly 1A. Further, to the rotary 90, trays 80y, 80m, 80c, and 80k which are mounting portions and mounting means are mounted. Further, to the trays 80y, 80m, 80c, and 80k, the toner cartridges (toner accommodating containers) 70y, 70m, 70c, and 70k are detachably mounted, respectively. Correspondingly to the developing unit 50y for yellow, the toner cartridge 70y for yellow is mounted to the tray 80y for yellow. Similarly, correspondingly to the developing unit 50m for magenta, the toner cartridge 70m for magenta is mounted to the tray 80m for magenta. Further, correspondingly to the developing unit 50c for cyan, the toner cartridge 70c for cyan is mounted to the tray 80c for cyan. Further, correspondingly to the developing unit 50k, the toner cartridge 70k for black is mounted to the tray 80k for black. The four developing units 50 are provided equidistantly with 90° about the rotational axis 90C of the rotary 90. The rotary developing device 91 is constituted by including the rotary (rotary main body) 90 provided with the developing units 50y, 50m, 50c, and 50k, the trays 80y, 80m, 80c, and 80k, and the toner cartridges 70y, 70m, 70c, and 70k. Incidentally, the developing units 50 may be made detachably mountable to the rotary 90. In a state in which each of the toner cartridges 70 is relative to the rotary 90 in a state in which the rotary 90 takes an exchange attitude described later, so that the toner cartridge 70 is demounted from and mounted to the apparatus main assembly 1A (rotary 90) through a mounting/demounting portion 15. At that time, the tray 80 is moved together with the toner cartridge 70, so that the toner cartridge 70 may be mounted to and demounted from the tray 80. Incidentally, the tray 80 may be formed integrally with the rotary 90.

Here, suffixes y, m, c, and k added to the developing units 50y, 50m, 50c, and 50k, the toner cartridges 70y, 70m, 70c, and 70k, the trays 80y, 80m, 80c, and 80k, and the like show colors of the toner, i.e., yellow, magenta, cyan, and black, respectively. In this embodiment, basic constitutions and functions of the developing units 50y, 50m, 50c, and 50k for the respective colors are substantially the same. Similarly, basic constitutions and functions of the toner cartridges 70y, 70m, 70c, and 70k for the respective colors are substantially the same. Further, in this embodiment, basic constitutions and functions of the trays 80y, 80m, 80c, and 80k for the respective colors are substantially the same. As regards elements, having identical or correspond functions, provided for the respective colors, these elements are collectively described by omitting the suffixes y, m, c, and k.

The developing units 50y, 50m, 50c, and 50k are an example of developing means each for developing (visualizing) the electrostatic latent image, formed on the surface of the photosensitive drum 2, with the toner supplied therefrom. The developing units 50y, 50m, 50c, and 50k develop the electrostatic latent images, formed on the surfaces of the photosensitive drums 2, with the toner of the respective colors of yellow, magenta, cyan, and black, so that the toner images (toner pictures, developer images) are formed on the surfaces of the photosensitive drums 2.

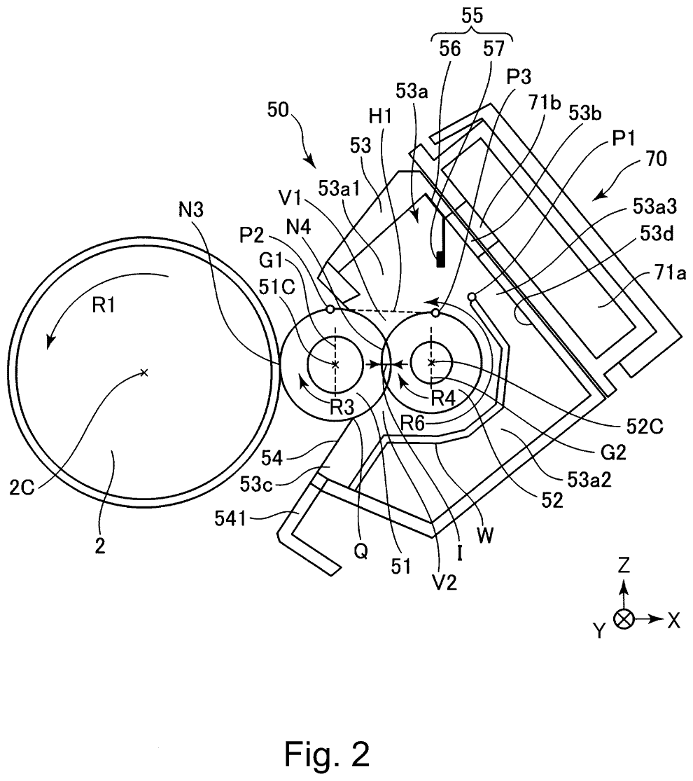

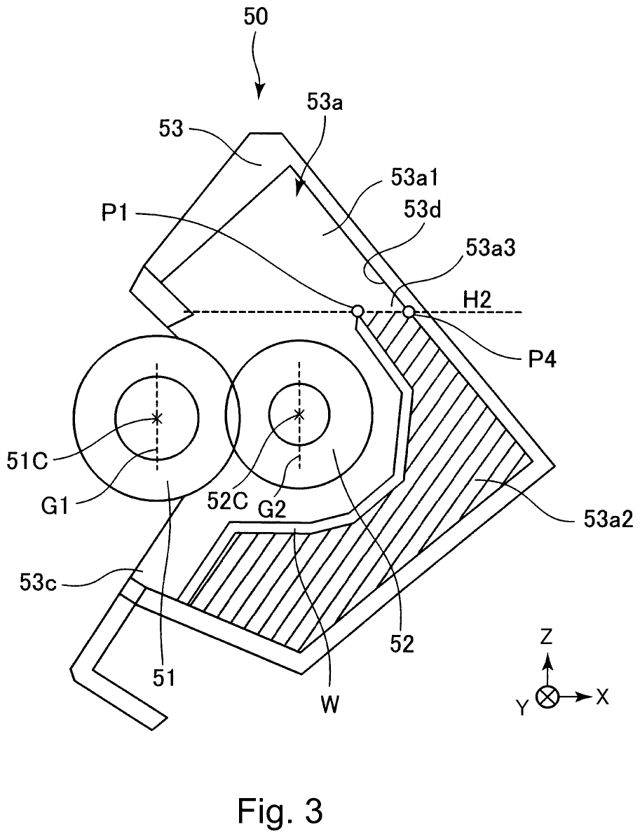

The developing unit 50 includes a developing roller 51, a supplying roller 52, and a developing blade 54 (FIG. 2). The region roller 51 is a developer carrying member (developing member) for supplying the toner to the photosensitive drum 2 by being rotated while carrying the toner as a developer. The supplying roller 52 is a supplying member provided in contact with the developing roller 51 and for supplying the toner to the developing roller 51. The developing blade 54 is a regulating member for regulating a thickness (toner amount) of a toner layer carried on the developing roller 51. Details of the developing unit 50 will be described later.

The rotary 90 rotates about the rotational axis 90C in an arrow R2 direction (clockwise direction) in FIG. 1. By this, the rotary 90 can take a “development attitude” in which the developing unit 50 for either one of the colors is in a developing position opposing the photosensitive drum 2. In this embodiment, when the developing unit 50 (developing roller 51) is in the “developing position”, the developing roller 51 of the developing unit 50 opposes (in this embodiment, contacts) the surface of the photosensitive drum 2. An attitude of the rotary 90 in which the developing unit 50y for yellow is in the developing position and the developing roller 51 thereof opposes the photosensitive drum 2 is referred to as a “yellow development attitude”. An attitude of the rotary 90 in which the developing unit 50m for magenta is in the developing position and the developing roller 51 thereof opposes the photosensitive drum 2 is referred to as a “magenta development attitude”. An attitude of the developing unit 50c for cyan is in the developing position and the developing roller 51 thereof opposes the photosensitive drum 2 is referred to as a “cyan development attitude”. An attitude of the rotary 90 in which the developing unit 50k for black is in the developing position and the developing roller 51 thereof opposes the photosensitive drum 2 is referred to as a “black development attitude”. That is, the rotary 90 is capable of rotating about the rotational axis 90C so that the position of the developing roller 51 of the developing unit 50 for each of the colors relative to the photosensitive drum 2 changes.

Further, the apparatus main assembly 1A includes a sheet accommodating portion 300, a pick-up roller 310, a feed roller 311, a separation roller 312, a conveying roller pair 320, a secondary transfer roller 12, a fixing device 40, and a secondary transfer unit 1a. The pick-up roller 310 is an example of a feeding means for feeding the sheet S. The feed roller 311 and the separation roller 312 (separation feeding (conveying) unit) are an example of a separation feeding (conveying) means for feeding (conveying) the sheet S while separating sheets S one by one by a frictional force. The secondary transfer roller 21 in an example of a secondary transfer means for transferring the image from an intermediary transfer member 10a onto the sheet S. The fixing device 40 is one example of a fixing means for fixing the toner image on the sheet S.

The intermediary transfer unit 10 includes the intermediary transfer member 10a, a belt driving roller 10b, a tension roller 10C, a belt cleaning device 13, and a primary transfer roller 11. The intermediary transfer member 10a is an example of an intermediary transfer member for carrying the image (toner image) transferred (primarily transferred) from the photosensitive drum 2 and for conveying the image so as to be transferred (secondarily transferred) onto the sheet S. The intermediary transfer member 10a constituted by an endless belt is extended around the belt driving roller 10b and the tension roller 10c which are used as stretching rollers, and is stretched under predetermined tension. The belt driving roller 10b is a driving member for conveying the intermediary transfer member 10a. The belt driving roller 10b is rotationally driven by a driving force transmitted from a motor (not shown) which is a driving source constituting an intermediary transfer member driving means. The tension roller 10c is an tension imparting member for imparting the predetermined tension to the intermediary transfer member 10a. On an inner peripheral surface side of the intermediary transfer member 10a, in a position corresponding to the photosensitive drum 2, the primary transfer roller 11 which is a roller-shaped primary transfer member as a primary transfer means is disposed. The primary transfer roller 11 presses the intermediary transfer member 10a toward the photosensitive drum 2, and forms a primary transfer portion (primary transfer nip) N1 which is a contact portion (nip) between the photosensitive drum 2 and the intermediary transfer member 10a. Further, on an outer peripheral surface side of the intermediary transfer member 10a, in a belt driving roller 10b also functioning as a secondary transfer opposite roller, the secondary transfer roller 12 which is a roller-shaped secondary transfer member as a secondary transfer means is disposed. The secondary transfer roller 12 is pressed toward the belt driving roller 10b and is contacted to the belt driving roller 10b through the intermediary transfer member 10a, and forms a secondary transfer portion (secondary transfer nip) N2 which is a contact portion (nip) between the intermediary transfer member 10a and the secondary transfer roller 12. The belt cleaning device 13 is an example of a cleaning means for removing the toner remaining on the surface of the intermediary transfer member 10a.

Incidentally, the photosensitive drum 2 may be made detachably mountable to the apparatus main assembly 1A substantially singly or in combination with at least one another element such as the charging roller 3 (charging means) or the cleaning unit 6 (cleaning means).

### 2. Image Forming Operation

Next, an image forming operation in the image forming apparatus 1 of this embodiment will be described.

The photosensitive drum 2 is rotationally driven in an arrow R1 direction (counterclockwise direction) in FIG. 1 by a driving force transmitted from a motor (not shown) which is a driving source constituting a photosensitive member driving means. Rotation of the photosensitive drum 2 is started in synchronism with rotation of the intermediary transfer member 10a. The intermediary transfer member 10a is rotated (circulated and moved) in an arrow R5 direction in FIG. 1 by transmission of the driving force thereto from the belt driving roller 10b. Then, the surface of the rotating photosensitive drum 2 is charged substantially uniformly to a predetermined polarity (negative polarity in this embodiment) by the charging roller 3.

In the case where a color image is formed on the sheet S, the charged surface of the photosensitive drum 2 is irradiated with laser light based on image data corresponding to a yellow image by the scanner, thus being subjected to scanning exposure. By this, an electrostatic latent image corresponding to the yellow image is formed on the surface of the photosensitive drum 2. In parallel to formation of this electrostatic latent image, the rotary 90 is rotated, so that the rotary 90 takes the yellow development attitude. The rotary 90 is rotated by a driving force transmitted from a motor which is a driving source constituting a rotary driving portion 92 as a rotary driving means. Then, the developing unit 50y for the yellow positioned in the developing position develops the electrostatic latent image, formed on the surface of the photosensitive drum 2, with toner of yellow. In this embodiment, the toner charged to the same polarity as a charge polarity (negative polarity in this embodiment) of the photosensitive drum 2 is deposited on an exposed portion (image portion) of the photosensitive drum 2 lowered in absolute value of potential by being exposed to light after being uniformly charged (reverse developing type). In this embodiment, a normal charge polarity of the toner, which is a primary charge polarity of the toner during the development is the negative polarity. In this embodiment, when the developing unit 50 is in the developing position, the developing roller 51 develops the electrostatic latent image in a state in which the developing roller 51 contacts the surface of the photosensitive drum 2. That is, the image forming apparatus 1 of this embodiment employs a contact development type. However, the present invention is not limited thereto, but the image forming apparatus may have a constitution in which the development of the electrostatic latent image is performed in a state in which a gap is formed in the developing position between the developer carrying member and the image bearing member. That is, the image forming apparatus 1 may employ a non-contact development type.

The yellow toner image formed on the surface of the photosensitive drum 2 is transferred (primarily transferred) onto the surface (outer peripheral surface) of the rotating intermediary transfer member 10a by the action of the primary transfer roller 11. During the primary transfer, to the primary transfer roller 11, a primary transfer voltage (primary transfer bias) of an opposite polarity (positive polarity in this embodiment) to the normal charge polarity is applied.

Thereafter, similarly as in the above-described manner, electrostatic latent images corresponding to the colors of magenta, cyan, and black are successively formed on the photosensitive drum 2. Further, every formation of the electrostatic latent image corresponding to the associated one of the colors, the rotary 90 is rotated, so that the developing units 50m, 50c, and 50k for the colors of magenta, cyan, and black, respectively, are successively moved to the developing position. Then, the toner image of the respective colors are formed on the photosensitive drum 2. Further, every formation of the toner image of each of the colors, onto the same image forming region of the intermediary transfer member 10a, the respective color toner images are successively transferred (primarily transferred) so as to be superposed on each other. That is, after the yellow toner image is formed on the intermediary transfer member 10a, the rotary 90 takes a magenta development attitude, so that a magenta toner image is formed on the intermediary transfer member 10a. After the magenta toner image is formed on the intermediary transfer member 10a, the rotary 90 takes a cyan development attitude, so that a cyan toner image is formed on the intermediary transfer member 10a. After the cyan toner image is formed on the intermediary transfer member 10a, the rotary 90 takes a black development attitude, so that a black toner image is formed on the intermediary transfer member 10a. Thus, the primary transfer is repeated so that the toner images of the four colors are superposed on each other on the intermediary transfer member 10a, so that a multiple toner image corresponding to an objective color image is formed on the intermediary transfer member 10a.

Incidentally, in the case where a monochromatic (black (single color) image) is formed on the sheet S, the rotary 90 takes the black development attitude. In this state, after the electrostatic latent image is formed on the surface of the photosensitive drum 2 by the charging and the exposure of the photosensitive drum 2, the electrostatic latent image is developed with black toner by the developing unit 50k for black disposed on the developing position. Subsequent steps are similar to those in the case where the color image is formed on the sheet S.

On the other hand, the sheet S is fed by the pick-up roller 310 from the sheet accommodating portion 300 provided at a lower portion of the apparatus main assembly 1A. The sheet S is fed to the conveying roller pair 320 in a state in which the sheets S are separated one by one by the feed roller 311 and the separation roller 312. The conveying roller pair 320 sends the fed sheet S to the secondary transfer portion N2 so that the sheet S is timed to the toner image on the intermediary transfer member 10a.

The toner image formed on the surface of the intermediary transfer member 10a is transferred (secondarily transferred) in the secondary transfer portion N2 onto the surface of the sheet S, nipped and conveyed by the intermediary transfer member 10a and the secondary transfer roller 12, by the action of the secondary transfer roller 12. During the secondary transfer, to the secondary transfer roller 12, a secondary transfer voltage (secondary transfer bias) of the opposite polarity (positive polarity in this embodiment) to the normal charge polarity of the toner is applied.

The sheet S on which the toner image is transferred is sent to the fixing device 40. The fixing device 40 heats and presses the sheet S carrying thereon an unfixed toner image, so that the toner image is fixed (melted, stuck) on the sheet S. The sheet S passed through the fixing device 40 is discharged (outputted) as a product, to a sheet discharge portion 14 provided outside (on an upper portion of) the apparatus main assembly 1A.

As described above, the toner cartridges 70y, 70m, 70c, and 70k are detachably mountable to the rotary 90. In the case where an amount of the toner in each of the toner cartridges 70y, 70m, 70c, and 70k becomes smaller than a predetermined amount (typically, in the case where the toner is substantially used up), an operator such as a user is capable of exchanging the toner cartridges 70y, 70m, 70c, and 70k. By this, it is possible to supply the toner to the image forming apparatus 1 (corresponding one of the developing units 50y, 50, 50c, and 50k).

### 3. Developing Unit

Next, the developing unit 50 in this embodiment will be described. FIG. 2 is a schematic sectional view of the developing unit 50. FIG. 2 shows a cross section, of the developing unit 50 in the developing position, substantially perpendicular to the rotational axis 51C of the developing roller 51. Incidentally, FIG. 2 also shows the photosensitive drum 2 and the toner cartridge 70, and in FIG. 2, the toner is omitted from illustration.

The developing unit 50 includes the developing frame 53 as the frame of the developing unit 50, the developing roller 51, the supplying roller 52, and the developing blade 54. Incidentally, the developing frame 53 may be separate member from the rotary 90 and may be mounted to the rotary 90, or may be formed integrally with the rotary 90.

### <Developing Roller>

The developing roller 51 is a roller having a multi-layer structure in which at a periphery of a core metal formed a metal material such as aluminum, aluminum alloy, stainless steel, or the like, an electroconductive elastic layer consisting of a base layer and a surface layer thereon. The base layer of the elastic layer is formed with a rubber such as nitrile-butadiene rubber (NBR) ethylene-propylene-diene-methylene (EPDM), a silicone rubber, and urethane rubber. Further, the surface layer of the elastic layer is formed with polyether urethane, nylon, or the like. However, a material of the elastic layer is not limited to these materials. For example, it is also possible to use a structure such that the base layer is formed with a foamed material, such as a sponge and a rubber elastic layer is formed as the surface layer. Or, the elastic layer may have single-layer structure consisting only of a rubber elastic layer of NBR, EPDM, or the urethane rubber. In this embodiment, the developing roller 51 is constituted by providing the electroconductive elastic layer on a periphery of a core metal of 6 mm in outer diameter so as to have an outer diameter of 10 mm.

The developing roller 51 is rotatably supported by the developing frame 53. When the rotary 90 takes the development attitude, the developing roller 51 of the developing unit 50 in the developing position is rotationally driven in an arrow R3 direction in FIG. 2 by a driving force transmitted from a motor (not shown) which is a driving source constituting a developing (roller) driving source. Further, when the developing unit 50 is in the developing position, the developing roller 51 of the developing unit 50 contacts the photosensitive drum 2 and forms a developing portion (developing nip) N3 which is a contact portion (nip) N3 between the photosensitive drum 2 and the developing roller 51. That is, in this embodiment, the developing roller 51 is rotationally driven so that the surface of the photosensitive drum 2 and the surface of the developing roller 51 move in the same (forward) direction in the developing portion N3.

The developing roller 51 is provided with a penetration amount regulating belt (not shown) at each of end portions with respect to a rotational axis direction (longitudinal direction). The developing unit 50 is constituted so that a penetration amount of the developing roller 51 into the surface of the photosensitive drum 2 becomes a predetermined value by contact of these penetration amount regulating rollers with the photosensitive drum 2.

Further, during the development, to the developing roller 51, a predetermined developing voltage (developing bias) of the same polarity as the normal charge polarity of the toner is applied by a developing power source (not shown) as a developing voltage applying means through a core metal.

### <Developing Blade>

The developing blade 54 is supported by a pressing plate 541 as a supporting member, and the pressing plate 541 is fixed to the developing frame 53. The developing blade 54 is a plate-shaped member with a predetermined thickness and with a predetermined length in each of a longitudinal direction of the developing roller 51 disposed substantially parallel to the rotational axis 51C and a widthwise direction perpendicular to the longitudinal direction. The developing blade 54 is fixed to the developing frame 53 by the pressing plate 541 at a fixing end portion which is one end portion with respect to the widthwise direction. Further, the developing blade 54 is provided so that a free end thereof on a free end portion side which is the other end portion with respect to the widthwise direction contacts the surface (outer peripheral surface) of the developing roller 51 in the neighborhood (side surface) of the free end. Here, a portion (contact portion between the developing roller 51 and the developing blade 54) where the developing roller 51 contacts the developing blade 54 with respect to a circumferential direction is referred to as a “regulating portion Q”. In the regulating portion Q, the developing blade 54 not only regulates a thickness (toner amount) of the toner layer on the developing roller 51 but also imparts an electric charge to the toner by friction. With respect to a rotational direction of the developing roller 51, the regulating portion Q is positioned on a side downstream of a supplying portion N4 described later and upstream of the regulating portion N3. In this embodiment, in the cross section shown in FIG. 2, the region portion Q is positioned on a side below the rotational axis 51C of the developing roller 51.

The developing blade 54 is constituted by a thin stainless steel plate, or a thin metal plate having spring elasticity, such as a thin phosphor bronze plate. Further, this developing blade 54 is contacted with linear pressure (contact pressure predetermined length of the developing roller 51 in the rotational axis direction) of the developing blade 54 to the developing roller 51.

Further, to the developing blade 54, a blade voltage (blade bias) is applied by a blade power source (not shown) as a blade voltage applying means through the pressing plate 541 so that a potential difference between the blade voltage and the potential of the developing roller 51 becomes a predetermined potential differences. In the case where the toner is negatively chargeable toner (toner of which normal charge polarity is the negative polarity), the blade voltage is set so that the potential (blade voltage) of the developing blade 54 is higher on the negative polarity side than the potential (developing voltage) of the developing roller 51. By this, the electric charge of the negative polarity is readily imparted to the toner.

In this embodiment, the developing blade 54 is constituted a 0.1 mm-thick stainless steel plate having spring elasticity. Further, in this embodiment, to the developing blade 54, as the blade voltage, −200 V relative to the potential of the developing roller 51 is applied.

Incidentally, as another example of the developing blade 54, the following constitution may be used. For example, a free end, with respect to the widthwise direction of a thin metal plate having spring elasticity is provided with an elastic member formed of polyamide elastomer or the like through bonding or injection molding. Then, a portion of this thin metal plate on an elastic member side with respect to the widthwise direction is contacted to the surface of the developing roller 51 with predetermined pressure.

### <Toner>

In this embodiment, as the developer, the toner which is 6 μm in average particle size and of which normal charge polarity is the negative polarity is used. In this embodiment, as an example, this toner is polymerization toner formed by a polymerization method. Further, in this embodiment, this toner is a so-called non-magnetic one-component developer which does not contain a magnetic component and which is carried on the developing roller 51 principally by intermolecular force or electrostatic force (mirror force). However, as the developer, a one-component developer containing the magnetic component may be used. Further, there are cases where in the one-component developer, additives (for example max and fine silica particles) for adjusting flowability and charging performance are contained in addition to toner particles. Further, as the developer, a two-component developer containing non-magnetic toner and a magnetic carrier may be used. In the case where a magnetic developer is used, as the developer carrying member, a cylindrical developing sleeve in which a magnet is provided inside the developing sleeve is used.

### <Peripheral Speed of Developing Roller>

A toner layer of the toner carried on the developing roller 51 is regulated in predetermined thickness by contact pressure by the developing blade 54. When the electrostatic latent image on the photosensitive drum 2 is developed, in order to obtain an appropriate image density, a peripheral speed (surface speed) of the developing roller 51 can be set to a speed different from a peripheral speed (surface speed) of the photosensitive drum 2. As a peripheral speed ratio which is a ratio of the peripheral speed of the developing roller 51 to the peripheral speed of the photosensitive drum 2, a range in which the peripheral speed of the developing roller 51 is 0.5 to 3.0 times the peripheral speed of the photosensitive drum 2 is suitable. Incidentally, as regards this numerical value range, the term “to” between the numerical values means that the range includes the numerical values before and after the term “to”. In this embodiment, this peripheral ratio was set so that the peripheral speed of the developing roller 51 is 1.5 times the peripheral speed of the photosensitive drum 2.

### <Supplying Roller>

The supplying roller 52 supplies the toner to the developing roller 51 in contact with the surface of the developing roller 51, and in addition, peels off and collects, from the developing roller 51, the toner (development residual toner) remaining on the developing roller 51 without being deposited on the photosensitive drum 2. The supplying roller 52 may preferably have the following constitution from viewpoints of supply the toner to the developing roller 51 and peeling-off of the development residual toner from the developing roller 51. For example, the constitution has a sponge structure in which a foamed elastic member layer is formed at a periphery of a core metal by using a foamed elastic member or has a fur brush structure formed by planting fibers such as rayon or nylon on a periphery of a core metal. Further, the sponge structure using the foamed elastic member can use inside cells of a closed-cell type in which the cells are independent of each other and inside cells of a continuous-cell type in which the cells are continuous with each other. However, the continuous-cell type is preferable because an amount of the toner stored inside the cells is large and therefore the toner can be stably supplied.

In this embodiment, the supplying roller 52 is a foam roller in which a foamed elastic member layer is provided on a periphery of a core metal formed of metal in an outer diameter of 5 mm so as to have a roller diameter of 11 mm. Further, in this embodiment, as the foamed elastic member constituting the supplying roller 52, a polyurethane foam of a continuous-cell type in which cells each having a diameter of 10 to 800 μm are continuous with each other and to which electroconductivity is imparted by dispersing therein an electroconductive agent such as carbon black was used. Thus, in this embodiment, the supplying roller 52 includes a foamed member (porous material member) at a surface (outer peripheral surface) thereof.

The supplying roller 52 is rotatably supported by the developing frame 53. When the rotary 90 takes the development attitude, the supplying roller 52 of the developing unit 50 in the developing position is rotationally driven in an arrow R4 direction (clockwise direction) in FIG. 2 by a driving force transmitted from a motor (not shown) which is a driving source constituting a developing driving means. Further, the supplying roller 52 contacts the developing roller 51 and forms a supplying portion (supplying nip) N4 which is a contact portion (nip) between the developing roller 51 and the supplying roller 52. That is, in this embodiment, the supplying roller 52 is rotationally driven so that in the supplying portion N4, the surface of the developing roller 51 and the surface of the supplying roller 52 are moved in opposite directions (counter directions).

### <Peripheral Speed and Potential of Supplying Roller>

In this embodiment, the peripheral speed (surface speed) of the supplying roller 52 was set so s to become 75% of the peripheral speed (surface speed) of the developing roller 51. However, the present invention is not limited thereto, but a ratio of the peripheral speed of the supplying roller 52 to the peripheral speed of the developing roller 51 can be appropriately set from the viewpoints of the supply of the toner to the developing roller 51 and the peeling-off of the development residual toner from the developing roller 51. Here, a penetration amount of the supplying roller 52 into the surface of the developing roller 51 may preferably be in a range of 0.1 to 1.5 mm from the viewpoints of the supply of the toner to the developing roller 51 and the peeling-off of the development residual toner from the developing roller 51. In this embodiment, the penetration amount of the supplying roller 52 into the surface of the developing roller 51 was set to 1.0 mm. Incidentally, the penetration amount (I in FIG. 2) of the supplying roller 52 into the surface of the developing roller 51 is represented by a maximum value of an amount in which the supplying roller 52 is crushed (deformed) by the developing roller 51 with respect to a rotational radius direction of the supplying roller 52.

Further, during development, to the supplying roller 52, a supplying voltage (supplying bias) is applied by a supplying (roller) power source (not shown) as a supplying voltage application means through the core metal so that a potential difference between the supplying voltage and the potential of the developing roller 51 becomes a predetermined potential difference. In the case where the toner is the negatively chargeable toner, the supplying voltage is set so that the potential (supplying voltage) of the supplying roller 52 is higher than the potential (developing voltage) of the developing roller 51 on a negative polarity side. By this, between the developing roller 51 and the supplying roller 52, an electric field in which the negatively chargeable toner is supplied from a supplying roller 52 side to a developing roller 51 side is formed. In this embodiment, to the supplying roller 52, as the supplying voltage, −200 V is applied relative to the potential of the developing roller 51.

Incidentally, a rotational axis 2C of the photosensitive drum 2, the rotational axis 51C of the developing roller 51, and a rotational axis 52C of the supplying roller 52 are substantially parallel to each other, and these rotational axes are substantially parallel to a rotational axis 90C of the rotary 90.

### <Developing Frame>

FIG. 3 is a schematic sectional view of the developing unit 50 for illustrating the developing frame 53 in the developing unit 50 in this embodiment. FIG. 3 shows a cross section substantially perpendicular to the rotational axis 51C of the developing roller 51 of the developing unit 50 disposed in the developing position. Incidentally, in FIG. 3, the toner is omitted from illustration.

As shown in FIG. 3, the developing frame 53 forms a developing chamber 53a capable of accommodating the toner. In this embodiment, the developing chamber 53a is partitioned into a first region 53a1 and a second region 53a2 by a partition wall W which is a wall constituted by a part of the developing frame 53. The partition wall W is provided over a whole region of the developing chamber 53a with respect to a longitudinal direction substantially parallel to the rotational axis 51C of the developing roller 51. The first region 53a1 and the second region 53a2 are connected in a connecting portion (connecting region) 53a3 described later, and communicate with each other by this connecting portion 53a3 so that the toner is movable therebetween. The first region 53a1 can be said as a region including the region roller 51 and the supplying roller 52 in the developing chamber 53a. Further, the second region 53a2 can be said as a region not including the developing roller 51 and the supplying roller 52 in the developing chamber 53a. The developing roller 51 supplies the toner, to the photosensitive drum 2, accommodated in the first region 53a1 in a state in which the developing roller 51 is disposed in the developing position. Further, the supplying roller 52 supplies the toner, to the developing roller 51, accommodated in the first region 53a1 in the state in which the developing roller 51 is disposed in the developing position.

The developing chamber 53a (developing frame 53) is provided with a development opening 53c in a region opposing the photosensitive drum 2 in the cross section shown in FIG. 3, and the developing roller 51 is disposed so that a part thereof is exposed to an outside of the developing chamber 53a (developing frame 53) through the development opening 53c. In the cross section shown in FIG. 3, the rotational axis 52C of the supplying roller 52 is positioned on an opposite side from the photosensitive drum 2 with respect to a vertical line G1 passing through the rotational axis 51C of the developing roller 51. Further, in this embodiment, in the cross section shown in FIG. 3, the rotational axis 51C of the developing roller 51 and the rotational axis 52C of the supplying roller 52 are positioned substantially at the same level in a vertical direction. However, the present invention is not limited thereto, but in the cross section shown in FIG. 3, the rotational axis 52C of the supplying roller 52 may be positioned on an upper side or a lower side relative to the rotational axis 51C of the developing roller 51 with respect to the vertical direction.

In the cross section shown in FIG. 3, an intersection point between a horizontal line H2 passing through an apex (highest position in the vertical direction) P1 of the partition wall W and an inner wall surface 53d on an opposite side from the developing roller 51 with respect to a vertical line G2 passing through the rotational axis 52C of the supplying roller 52 in the developing frame 53 is P4. In this case, the first region 53a1 and the second region 53a2 is connected in a line segment from P1 to P4. That is, this line segment from P1 to P4 corresponds to the connecting portion 53a3 between the first region 53a1 and the second region 53a2. In this embodiment, in the cross section shown in FIG. 3, the connecting portion 53a3 is positioned on an opposite side from the developing roller 51 with respect to the vertical line G2 passing through the rotational axis 52C of the supplying roller 52. Further, in this embodiment, the connecting portion 53a3 is formed by the apex P1 of the partition wall W and the inner wall surface 53d. The toner in the developing chamber 53a is movable not only from the first region 53a1 to the second region 53a2 but also from the second region 53a2 to the first region 53a1 by rotation of the rotary 90 in the arrow R2 direction in FIG. 1.

The connecting portion 53a3 can be said as a space connecting the first region 53a1 and the second region 53a2. Further, the connecting portion 53a3 can be said as a boundary between the first region 53a1 and the second region 53a2. The connecting portion (space) 53a3 includes an opening defined by an end of the partition wall W and the developing frame 53. The toner in the first region 53a1 passes through the opening defined by the end of the partition wall W and the developing frame 53 and is movable to the second region 53a2. Further, the toner in the second region 53a2 passes through the opening defined by the end of the partition wall W and the developing frame 53 and is movable to the first region 53a1.

### <Partition Wall>

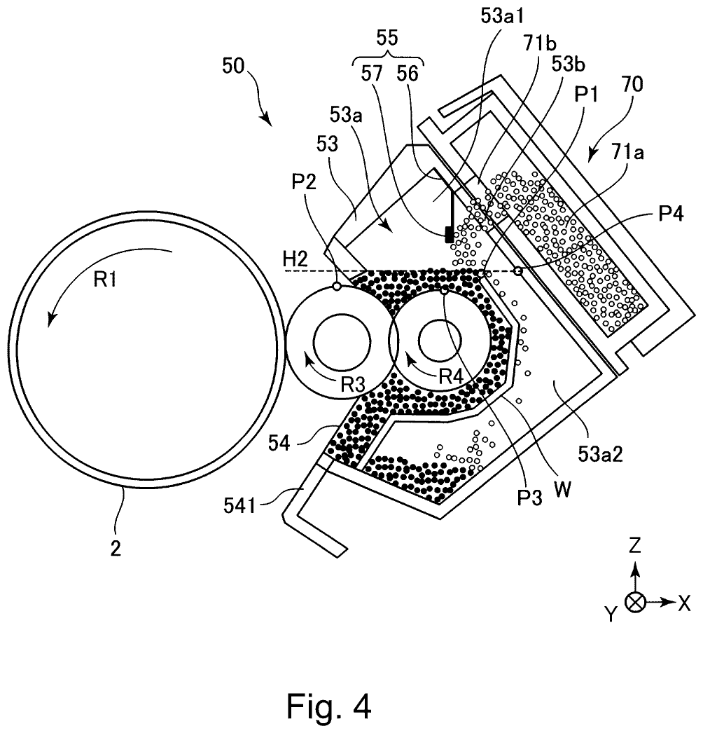

FIG. 4 is a schematic sectional view of the developing unit 50 for illustrating a position of the partition wall W in the developing unit 50 of this embodiment. FIG. 4 shows a cross section substantially perpendicular to the rotational axis 51C of the developing roller 51 of the developing unit 50 in the developing position. Incidentally, in FIG. 4, the photosensitive drum 2 and the toner cartridge 70 are also shown. Further, in FIG. 4, “new toner” is indicated by a white circle “◯”, and “deteriorated toner” is indicated by a black circle (dot) “ [symbol] ”. Details of the “new toner” and the “potential” will be described later.

In the cross section shown in FIG. 4, a height of a surface of the toner in the first region 53a1 is most determined as a position of the horizontal line H2 passing through the apex P1 by the apex P1 of the partition wall W. In the cross section shown in FIG. 4, the apex p1 of the partition wall W may desirably be positioned on an upper side with respect to the vertical direction relative to an apex P2 of the developing roller 51 and an apex P3 of the supplying roller 52.

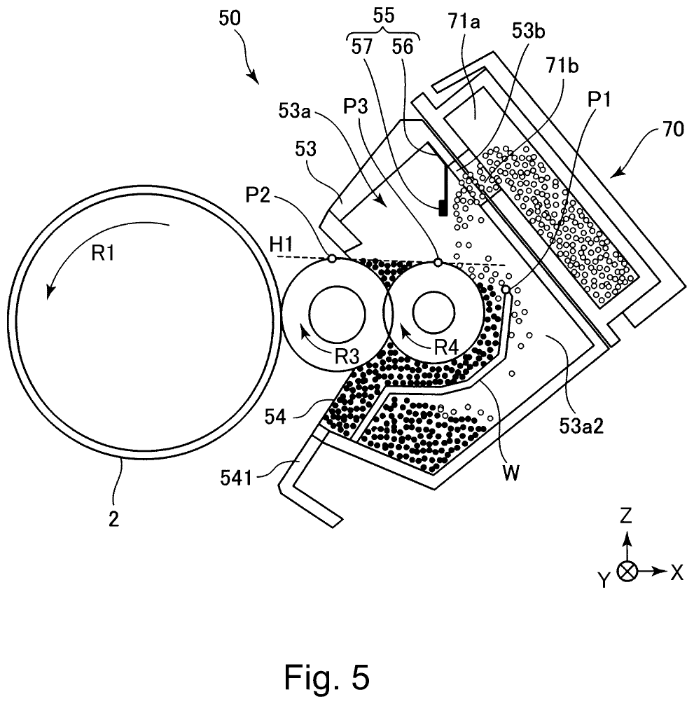

FIG. 5 is a schematic sectional view similar to FIG. 4 and shows a developing unit 50 different from the developing unit 50 shown in FIG. 4 in position of the apex P1 of the partition wall W. As shown in FIG. 5, in the case where the apex P1 of the partition wall W is positioned on a lower side with respect to the vertical direction relative to the apex P2 of the developing roller 51 and the apex P3 of the supplying roller 52, a height of the surface of the toner in the first region 53a1 becomes a height in a position of a line H1 almost passing through the apex P2 of the developing roller 51 and the apex P3 of the supplying roller 52. In this case, for example, when printing high in print ratio is repeated in monochromatic continuous printing, there is a possibility that the following phenomenon occurs. That is, when the toner accumulated in a region V1 in the neighborhood of a downstream side of the supplying portion N4 with respect to the rotational direction (arrow R4 direction in FIG. 5) of the supplying roller 52 shown in FIG. 2 (hereinafter, this region is referred to as a “supplying portion downstream region”) is consumed, thereafter, the toner cannot be sufficiently supplied to the developing roller 51, so that there is a possibility that a white void of the image occurs. Incidentally, the supplying portion downstream region V1 is, specifically, a region surrounded by the developing roller 51, the supplying roller 52, and the above-described line H1.

Accordingly, in this embodiment, the developing unit 50 is constituted so that as shown in FIGS. 2 to 4, the apex P1 of the partition wall W is positioned on the upper side with respect to the vertical direction relative to the apex P2 of the developing roller 51 and the apex P3 of the supplying roller 52. By this, the number of printed sheets until the white void of the image occurs can be increased.

In this embodiment, in the cross section shown in FIG. 2, the partition wall W is formed so as to extend from a position below the developing roller 51 toward below the supplying roller 52 and then to the apex P1 along an outer peripheral surface of the supplying roller 52. In the cross section shown in FIG. 2, the connecting portion 53a3 opens from the lower second region 53a2 toward the upper first region 53a1.

### <Position of Toner Supply Opening>

As shown in FIG. 2, the developing frame 53 is provided with a receiving opening 53b for permitting reception of the toner into the developing chamber 53a. Further, the toner cartridge 70 is provided with a discharge opening 71b for permitting discharge of the toner accommodated in a toner accommodating portion (accommodating chamber) 71a in a position corresponding to the receiving opening 53b of the developing frame 53 in a state in which the toner cartridge 70 is mounted to the rotary 90 through the tray 80. The developing chamber 53a of the developing frame 53 (developing unit 50) and the toner accommodating portion 71a of the toner cartridge 70 communicate with each other through the receiving opening 53b of the developing frame 53 and the discharge opening 71b of the toner cartridge 70.

In this embodiment, the receiving opening 53b is disposed in the first region 53a1 of the developing chamber 53a. That is, in the state in which the developing roller 51 is disposed in the developing position, with respect to the vertical direction, the receiving opening 53b and the discharge opening 71b are positioned above a horizontal line passing through the apex of the partition wall W. Incidentally, in this embodiment, in the cross section shown in FIG. 2, the receiving opening 53b is positioned on an opposite side from the developing roller 51 with respect to a vertical line passing through the supplying portion N4. Particularly, in this embodiment, the receiving opening 53b is positioned on an opposite side from the developing roller 51 with respect to the vertical line G2 passing through the rotational axis 52C of the supplying roller 52. Although described later specifically, as shown in FIG. 4, the new toner is supplied into the developing chamber 53a through the receiving opening 53b.

### <Non-Return Valve>

As shown in FIG. 2, in order to suppress a backflow of the toner from the developing chamber 53a toward the toner accommodating portion 71a, a non-return valve 55 as a back-flow suppressing means is provided. In this embodiment, the non-return valve 55 is constituted by a door-like structure provided in the developing chamber 53a and capable of opening and closing the receiving opening 53b. The non-return valve 55 includes a door portion 56 constituted by Mylar, and a weight 57. In the cross section shown in FIG. 2, a fixing end portion which is an upper-side end portion of the door portion 56 is fixed to the inner wall surface 53d of the developing frame 53 positioned above the receiving opening 53b. In this embodiment, the door portion 56 is fixed to the inner wall surface 53d of the developing frame 53 through a double-side tape as a fixing means. However, the present invention is not limited thereto, but the door portion 56 can be fixed to the developing frame 53 by an arbitrary fixing means such as bonding, welding, or fastening. Further, in the cross section shown in FIG. 2, the other end portion of the door portion 56 on a lower side is a free end portion, and the weight 57 is mounted on this free end portion of the door portion 56.

The non-return valve 55 opens and closes the receiving opening 53b by being moved by gravitation with rotation of the rotary 90 in the arrow R2 direction in FIG. 1. Although described later specifically, the non-return valve 55 is closed when the developing unit 50 is in positions of parts (a) to (c) of FIG. 7 and parts (a) to (d) of FIG. 8, and is opened when the developing unit 50 is in positions of parts (d) to (g) of FIG. 7 and parts (e) to (h) of FIG. 8. By the close of the non-return valve 55, movement of the toner from the toner accommodating portion 71a into the developing chamber 53a is suppressed (substantially stopped in this embodiment).

### <Mechanism of Peeling Off, Supply, and Circulation>

In this embodiment, as shown in FIG. 2, the supplying roller 52 contacts the developing roller 51 with a predetermined penetration amount relative to the developing roller 51 in the supplying portion N4 which is the contact portion (nip) between the developing roller 51 and the supplying roller 52. For that reason, the cells of the foamed elastic member layer of the supplying roller 52 contact the developing roller 51 in a state in which the cells are crushed (compressed) in the supplying portion N4.

By rotation of the supplying roller 52, on a side downstream of the supply portion N4 with respect to the rotational direction (arrow R4 direction in FIG. 2), the cells of the supplying roller 52 are released from the crushed state, and then not only take in the toner in the supplying portion downstream region V1 but also peel off and collect the toner from the developing roller 51 by a cell wall.

Further, on a side upstream of the supplying portion N4 with respect to the rotational direction of the supplying roller 52, the cells of the supplying roller 52 are crushed, whereby the toner in the cells of the supplying roller 52 is not only discharged but also supplied onto the developing roller 51. Thereafter, by the developing blade 54, the electric charge is imparted to the toner on the developing roller 51, and in addition, a thickness (toner supply amount) of the toner layer on the developing roller 51 is regulated.

At this time, the toner in a region V2 in the neighborhood of an upstream side of the supplying portion N4 with respect to the rotational direction of the supplying roller 52 (hereinafter, this region is referred to as a “supplying portion upstream region”) is moved in the following manner. That is, the toner in the region V2 is pressed by the toner discharged from the supplying roller 52 and is moved in an opposite direction to the rotational direction of the supplying roller 52, as indicated by an arrow R6 in FIG. 2. The toner moved in the arrow R6 direction in FIG. 2 is circulated to the supplying portion downstream region V1 and then is taken again in the cells of the supplying roller 52. Incidentally, the supplying portion upstream region V2 is, specifically, a region surrounded by the developing roller 51, the supplying roller 52, and a line passing through a lowermost point of the developing roller 51 and a lowermost point of the supplying roller 52.

Thus, the toner accommodated in the first region 53a1 of the developing chamber 53a is circulated along the arrow R6 direction in FIG. 2 which is the opposite direction to the rotational direction of the supplying roller 52.

### 4. Suppression of Supply Fog

### <Second Region>

As one of features of the image forming apparatus 1 of this embodiment, it is possible to cite that the developing chamber 53a is provided with the second region 53a2. As described later specifically, by presence of the second region 53a2, the new toner and the deteriorated toner are uniformly mixed with each other and then are supplied onto the developing roller 51. As a result, it is possible to suppress the supply fog caused by that the new toner takes the electric charge from the deteriorated toner.

### <Supply Fog>

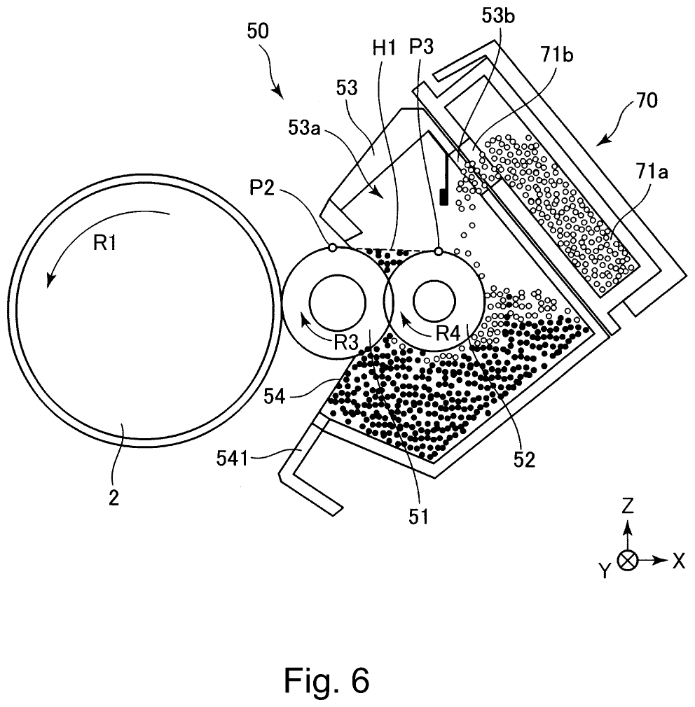

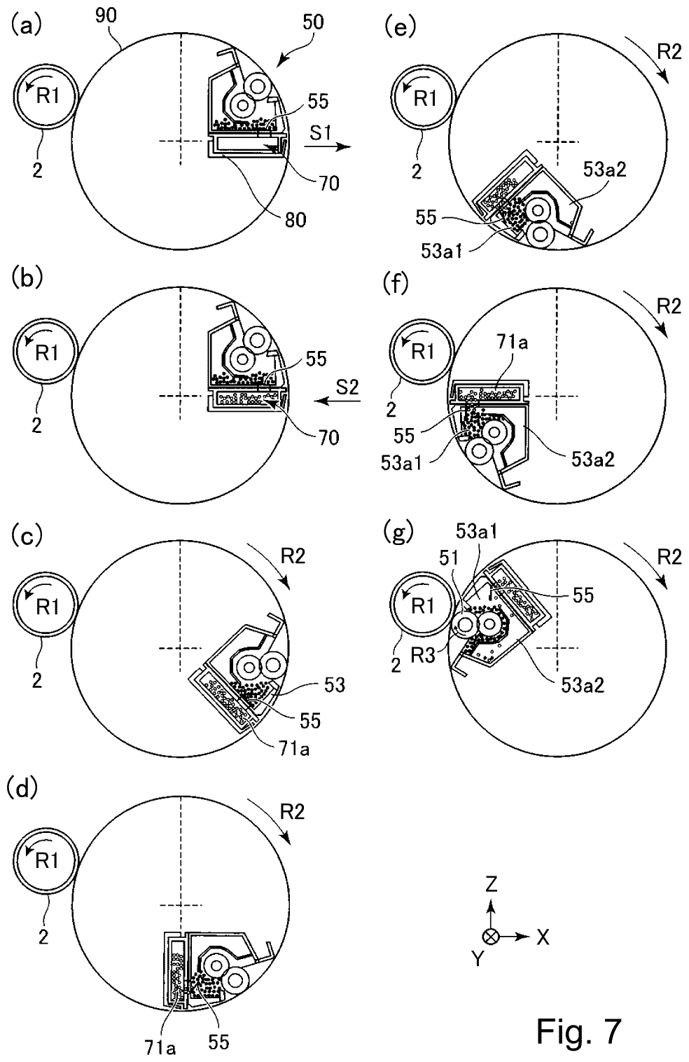

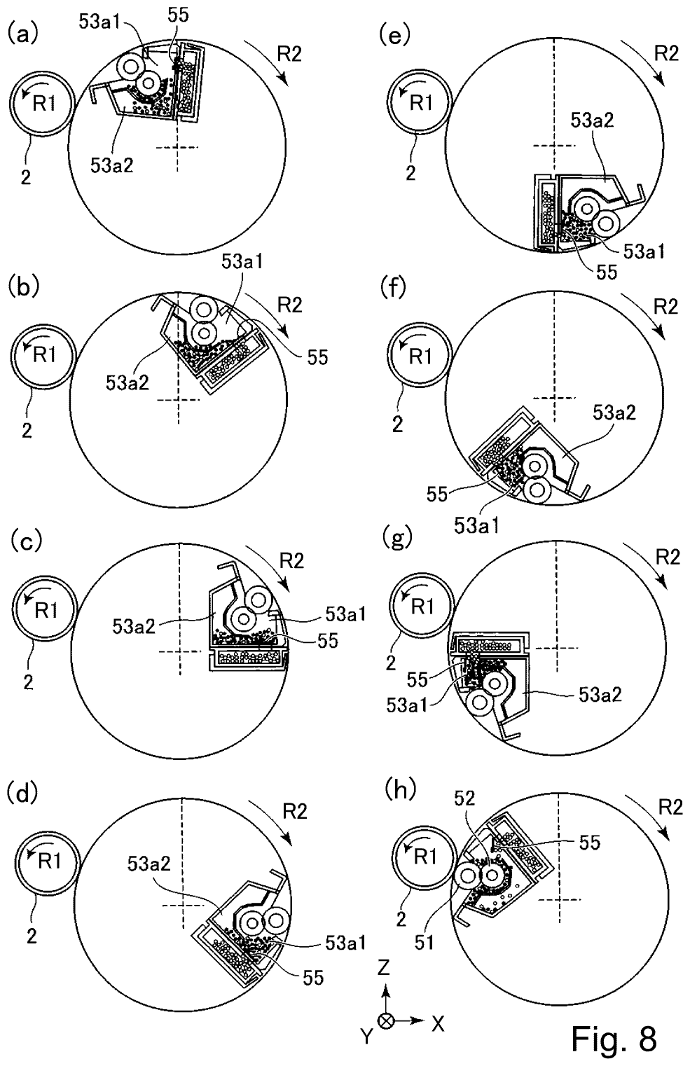

Here, the supply fog will be described using a comparison example. FIG. 6 is a schematic sectional view of a developing unit 50 in the comparison example. FIG. 6 shows a cross section substantially perpendicular to a rotational axis 51C of a developing roller 51 of the developing unit 50 positioned in a developing position, in the comparison example. Incidentally, in FIG. 6, a photosensitive drum 2 and a toner cartridge 70 are also shown. Further, also in FIG. 6, the “new toner” is indicated by the white circle “◯”, and the “deteriorated toner” is indicated by the black circle “ [symbol] ”. Further, as regards the comparison example, elements having identical or corresponding functions or constitution to those in this embodiment will be described by adding thereto the same reference numerals or symbols.

The developing unit 50 in the comparison example is different from the developing unit 50 in this embodiment in that there is no partition wall W for partitioning a region of the developing chamber 53a and in that the developing chamber 53a comprises a single region including the developing roller 51 and the supplying roller 52. Other points of the developing unit 50 in the comparison example are substantially the same as those of the developing unit 50 in this embodiment.

In the developing unit 50 in the comparison example, the new toner accommodated in the toner accommodating portion 71a is discharged through the discharge opening 71b, and the toner discharged through this discharge opening 71b is directly moved into the developing chamber 53a comprising the single region through the receiving opening 53b.

Incidentally, the toner carried on the developing roller 51 is subjected to mechanical stress by being rubbed with the developing blade 54, the photosensitive drum 2, the supplying roller 52, and the like. By this, a phenomenon such that an external additive on surfaces of toner particles of the toner is detached or such that the toner particles are irregularly shaped occurs, so that the toner is in a state in which the toner is not readily charged to the normal charge polarity. The toner in such a state is referred to as the “deteriorated toner”. On the other hand, the toner which is accommodated in the toner accommodating portion 71a and not subjected to the above-described rubbing and which is in a state in which the toner is more readily charged to the normal charge polarity than the deteriorated toner is referred to as the “new toner”. When the deteriorated toner and the new toner which are different in state are mixed with each other, the new toner readily charged to the normal charge polarity takes the electric charge from the deteriorated toner, so that there is a tendency that the electric charge of the deteriorated toner remarkably lowers.

In the developing unit 50 in the comparison example, a region in which the new toner is supplied and a region in which the developing roller 51 and the supplying roller 52 are provided are the same region. Accordingly, when the new toner is supplied through the receiving opening 53b to the neighborhood of the supplying roller 52 in the developing chamber 53a, the toner in the neighborhood of the surface of the supplying roller 52 is circulated along the rotational direction (arrow R4 direction in FIG. 6) of the supplying roller 52. By this, the new toner is moved to the neighborhood of the upstream side of the supplying portion N4 with respect to the rotational direction of the supplying roller 52. Thus, when the new toner moved to the neighborhood of the upstream side of the supplying portion N4 with respect to the rotational direction of the supplying roller 52 is rubbed with the deteriorated toner in the neighborhood thereof, the deteriorated toner in a state in which the electric charge thereof is remarkably low becomes liable to be supplied to the developing roller 51. As a result, the electric charge cannot be completely replenished by the developing blade 54, so that an image defect called a “fog” such that the toner is deposited on a region (non-image forming portion) of the surface of the photosensitive drum 2 on which the electrostatic latent image is not formed occurs in some instances. Such an image defect is referred to as the “supplying fog”.

### <Mechanism of Supplying Fog Suppression>

Next, a mechanism (mechanism of toner mixing) of suppression of the supply fog in the developing unit 50 in this embodiment will be described. FIGS. 7 and 8 are schematic sectional views of a rotary developing device 91 for illustrating the mechanism of toner mixing in the developing unit 50 with rotation of the rotary 90 (showing a cross section substantially perpendicular to the rotational axis 90C of the rotary 90).

Incidentally, in FIGS. 7 and 8, only a single developing unit 50 and a toner cartridge 70 corresponding thereto are shown. Further, in FIGS. 7 and 8, the “new toner” is indicated by the white circle “◯”, and the “state” is indicated by the black circle “ [symbol] ”.

Part (a) of FIG. 7 shows a state in which the rotary 90 takes an “exchange attitude” such that the toner cartridge 70 is electric chargeable (detachably mountable) and in which the illustrated single developing unit 50 is in an “exchanging position” where the toner cartridge 70 is exchangeable (detachably mountable). In the state of part (a) of FIG. 7, the non-return valve 55 is closed.

Incidentally, the rotary 90 takes the development attitude every rotation of an even multiple of about 45° in the arrow R2 direction in FIG. 2 from a state in which the rotary 90 takes the development attitude (every rotation of about 90°). Further, the rotary 90 takes the exchange attitude every rotation of an odd multiple of about 45° in the arrow R2 direction in FIG. 2 from the state in which the rotary 90 takes the development attitude (every rotation of about 90° in the arrow R2 direction in FIG. 2 from a state in which the rotary 90 takes the exchange attitude.

As shown in part (a) of FIG. 7, when the rotary 90 takes the exchange attitude, the toner cartridge 70 corresponding to the developing unit 50 in the exchanging position is slid toward an outside of the rotary 90 in a rotation radius direction shown by an arrow S1 in part (a) of FIG. 7. By this, the toner cartridge 70 is demounted (detached) from the apparatus main assembly 1A (rotary 90). On the other hand, as shown in part (b) of FIG. 7, when the rotary 90 takes the exchange attitude, the toner cartridge 70 corresponding to the developing unit 50 in the exchanging position is slid toward an inside of the rotary 90 in the rotation radius direction shown by an arrow S2 in part (b) of FIG. 7. By this, the toner cartridge 70, typically, a new (brand-new) toner cartridge 70 is mounted to the apparatus main assembly 1A (rotary 90). Incidentally, the toner cartridge 70 may be slid (mounted and demounted) by an operation of an operator or may be provided with a mechanism for sliding (mounting and demounting) the toner cartridge 70 relative to the image forming apparatus 1. Such a mechanism may be constituted so as to be operated on the basis of an instruction from the operator or the operation by the operator.

Part (c) of FIG. 7 shows a state in which the rotary 90 is rotated from the state of part (a) of FIG. 7 in the arrow R2 direction by about 45°. In the following, each of parts (d) to (g) of FIG. 7 and parts (a) to (h) of FIG. 8 also similarly shows a state in which the rotary 90 is rotated from a previous state by about 45°.

In the state of part (c) of FIG. 7, the non-return valve 55 is closed, and therefore, movement of the new toner from the toner accommodating portion 71a into the developing frame 53 and movement of the toner in an opposite direction thereto do not occur.

In the state of part (d) of FIG. 7, the non-return valve 55 starts to open, so that the toner starts to move from the toner accommodating portion 71a to the developing frame 53.

In the state of part (e) of FIG. 7, the non-return valve opens, so that the new toner moves from the toner accommodating portion 71a to the first region 53a1.

In the state of part (f) of FIG. 7, the new toner further moves from the toner accommodating portion 71a to the first region 53a1.

In the state of part (g) of FIG. 7, the illustrated single developing unit 50 is in a state in which the rotary 90 in the developing position similar to the positions of FIGS. 2 and 4 takes the development attitude. In this state, the developing roller 51 and the supplying roller 52 are rotated, so that the toner is supplied to the developing roller 51 and the image forming operation (developing operation) is performed.

In the state of part (g) of FIG. 7, the toner positioned on an upper side in the vertical direction relative to the horizontal line H2 passing through the apex P1 of the partition wall W shown in FIG. 4 is dropped from the first region 53a1 into the second region 53a2. By this, most of the new toner supplied to the first region 53a1 is dropped into the second region 53a2, and therefore, the new toner is hardly present in the first region 53a1. As a result, the new toner is taken in the cells of the supplying roller 52 in the supplying portion downstream region V1 shown in FIG. 2 and is moved in the rotational direction (arrow R4 direction in FIG. 2) of the supplying roller 52, and thereafter, movement of the new toner to the supplying portion upstream region V2 shown in FIG. 2 is suppressed. Accordingly, it is possible to suppress that the supplying fog occurs.

On the other hand, in the state of part (g) of FIG. 7, in the second region 53g2, the deteriorated toner and the new toner are mixed and rubbed with each other, so that the electric charge of the deteriorated toner from which the external additive is detached or in which the external additive is embedded is remarkably taken by the new toner on which the external additive is deposited in a large amount. Thus, by rotation of the rotary 90, the toner accommodated in the toner cartridge 70 and the toner accommodated in the first region 53a1 are moved to the second region 53a2 and are mixed with each other.

In the state of part (a) of FIG. 8, the toner is moved from the first region 53a1 to the second region 53a2. Further, the non-return valve is closed. Further, in the second region 53a2, the deteriorated toner remarkably losing the electric charge in the state of part (g) of FIG. 7 and normal deteriorated toner moved from the first region 53a1 to the second region 53a2 in the state of part (a) of FIG. 8 are mixed and rubbed with each other. By this, the toner remarkably losing the electric charge takes back the electric charge from the normal deteriorated toner, so that the electric charge is restored. Incidentally, the “normal deteriorated toner” is the deteriorated toner from which the electric charge is not remarkably taken by the new toner.

In the states of parts (b) to (e) of FIG. 8, from the second region 53a2 to the first region 53a1, the toner mixed in the second region 53a2 is returned, and in addition, is mixed. By this, the electric charge of the toner remarkably losing the electric charge is further restored.

In the states of parts (f) and (g) of FIG. 8, the toner is further mixed in the first region 1. By this, the electric charge of the toner remarkably losing the electric charge is further restored.

Here, the non-return valve 55 starts to open in the state of part (e) of FIG. 8, and is open in the states of parts (f) and (g) of FIG. 8. For that reason, in the states of parts (f) and (g) of FIG. 8, the new toner is moved from the toner accommodating portion 71a to the first region 53a1. However, the new toner moved into the first region 53a1 is blocked by another toner in the first region 53a1. That is, the toner moved from the toner cartridge 70 to the developing chamber 53a is suppressed from remaining in the first region 53a1 by the toner moved from the second region 53a2 to the first region 53a1 with the rotation of the rotary 90, and thus is movable to the second region 53a2. As a result, the new toner is taken in the cells of the supplying roller 52 in the supplying portion downstream region V1 shown in FIG. 2 and is moved in the rotational direction (arrow R4 direction in FIG. 2) of the supplying roller 52, and thereafter, is suppressed from moving to the supplying portion upstream region V2 shown in FIG. 2. Accordingly, it is possible to suppress that the supply fog occurs.

The state of part (h) of FIG. 8 is a state in which the rotary 90 takes the development attitude after being rotated once from the state of part (g) of FIG. 7. In this state, the toner is supplied to the developing roller 51 by rotation of the developing roller 51 and the supplying roller 52, so that the image forming operation (developing operation) is performed. Here, as described above, in the first region 53a1, the toner is sufficiently mixed, and the electric charge is averages, so that the toner remarkably losing the electric charge hardly exists. Accordingly, it is possible to suppress that the supply fog as in the case of the developing unit 50 in the above-described comparison example occurs.

Thus, in this embodiment, the image forming apparatus 1 includes the image bearing member (photosensitive drum) 2 on which the electrostatic latent image is formed; the rotary 90 including the developing chamber 53a for accommodating the toner and the developing member (developing roller) 51 for developing the electrostatic latent image by supplying the toner, the image bearing member 2, the toner accommodated in the developing chamber 53a and rotatable so as to move the developing member 51 to the developing position where the developing member 51 supplies the toner to the image bearing member 2; and the toner cartridge 70 accommodating the toner supplied to the developing chamber 53a and detachably mounted to the rotary 90. The receiving opening 53b provided in the developing chamber 53a and the discharge opening 71b provided in the toner cartridge 70 communicate with each other, so that the toner is supplied from the toner cartridge 70 into the developing chamber 53a. Further, in this embodiment, the developing chamber 53a includes the partition wall W for partitioning the developing chamber 53a into the first region 53a1 including the developing member 51 and the second region 53a2, and by the rotation of the rotary 90, the toner accommodated in the toner cartridge 70 and the toner accommodated in the first region 53a1 are moved to the second region 53a2 and then are mixed in the second region 53a2. Further, in this embodiment, in the state in which the developing member 51 is disposed in the developing position, with respect to the vertical direction, the receiving opening 53b and the discharge opening 71b are positioned above the horizontal line passing through the apex of the partition wall W. Further, in this embodiment, the toner moved from the toner cartridge 70 to the developing chamber 53a is suppressed from retaining in the first region 53a1 by the toner moved from the second region 53a2 to the first region 53a1 with the rotation of the rotary 90, and thus is movable to the second region 53a2. Further, in this embodiment, in the state in which the developing member 51 is disposed in the developing position, with respect to the vertical direction, the apex of the partition wall W is positioned above the above-described of the developing member 51. Further, in this embodiment, the rotary 90 is provided with the supplying member (supplying roller) 52 for supplying, to the developing member 51, the toner accommodated in the first region 53a1 in the state in which the developing member 51 is disposed in the developing position. Further, in this embodiment, in the state in which the developing member 51 is disposed in the developing position, with respect to the vertical direction, the apex of the partition wall W is positioned above the apex of the developing member 51 and the apex of the supplying roller 52.

As described above, in this embodiment, the image forming apparatus 1 includes the partition wall W for partitioning the first region 53a1 and the second region 53a2 of the developing chamber 53a. By this, it is possible to suppress that the supply fog occurs.

### Embodiment 2

Next, another embodiment of the present invention will be described. Basic constitutions and operations of an image forming apparatus in this embodiment are the same as those of the image forming apparatus of the embodiment 1. Accordingly, in the image forming apparatus of this embodiment, elements having the same or corresponding functions or constitutions as those of the image forming apparatus of the embodiment 1 are represented by the same reference numerals or symbols as those in the embodiment 1 and will be omitted from detailed description.

1. Outline of this Embodiment

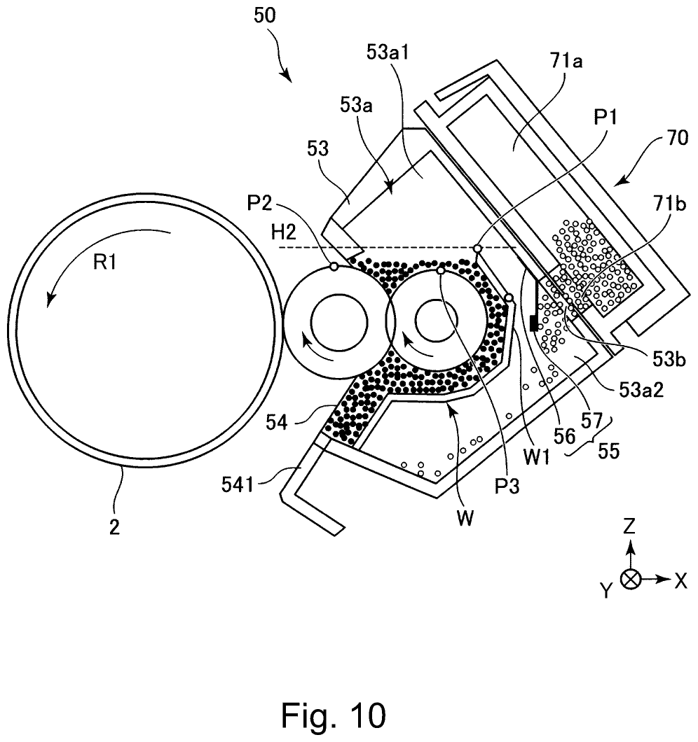

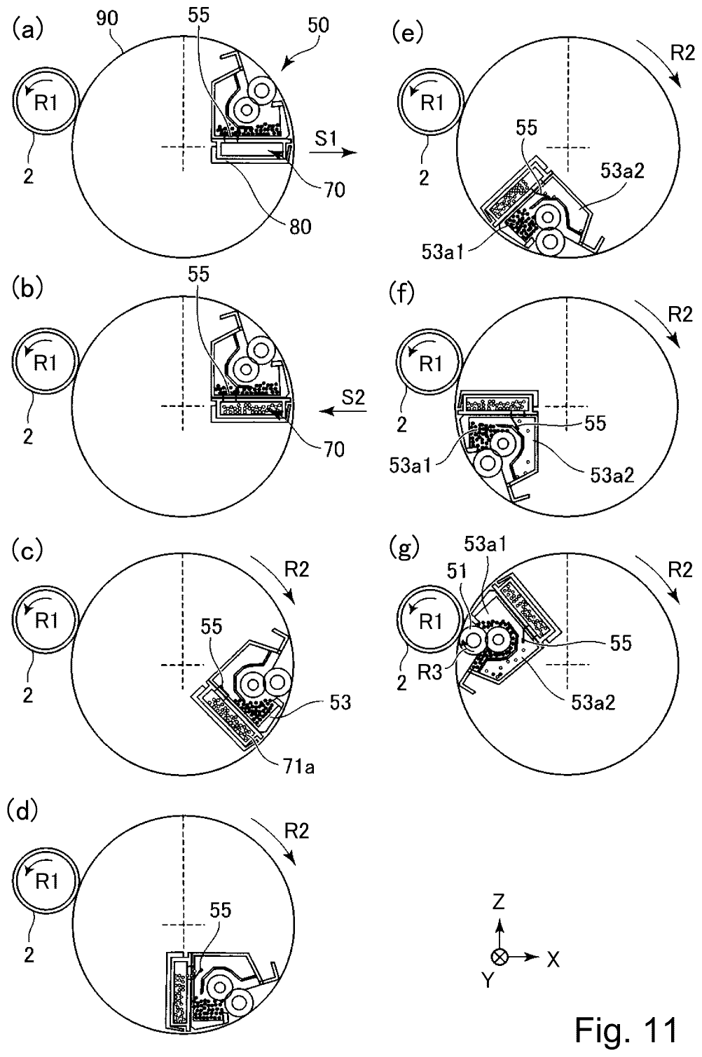

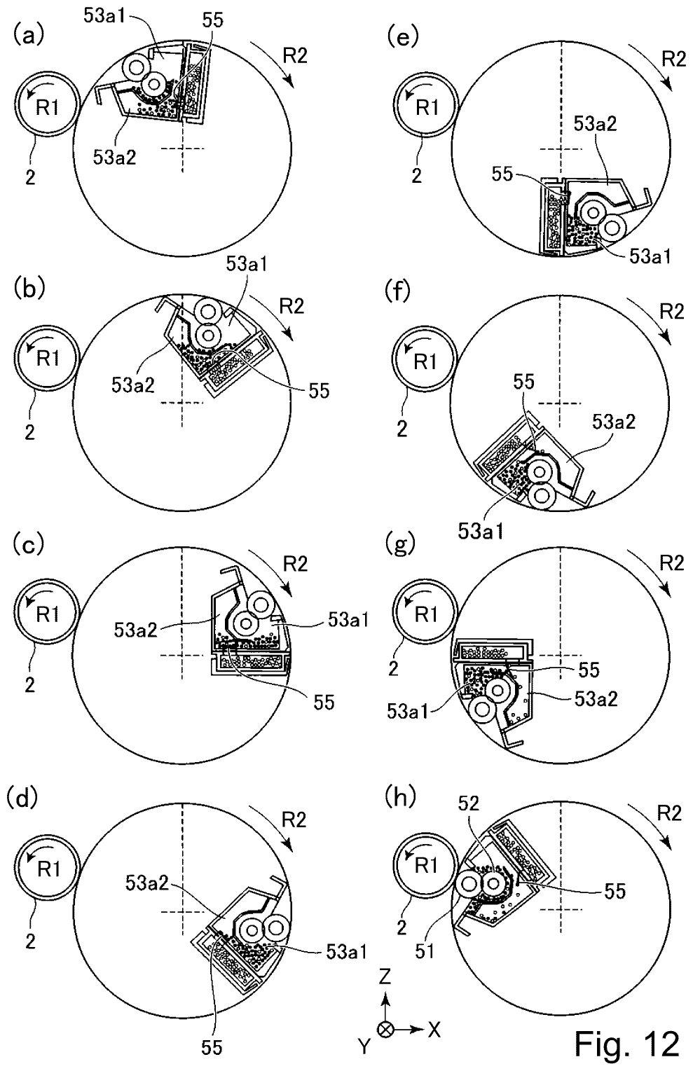

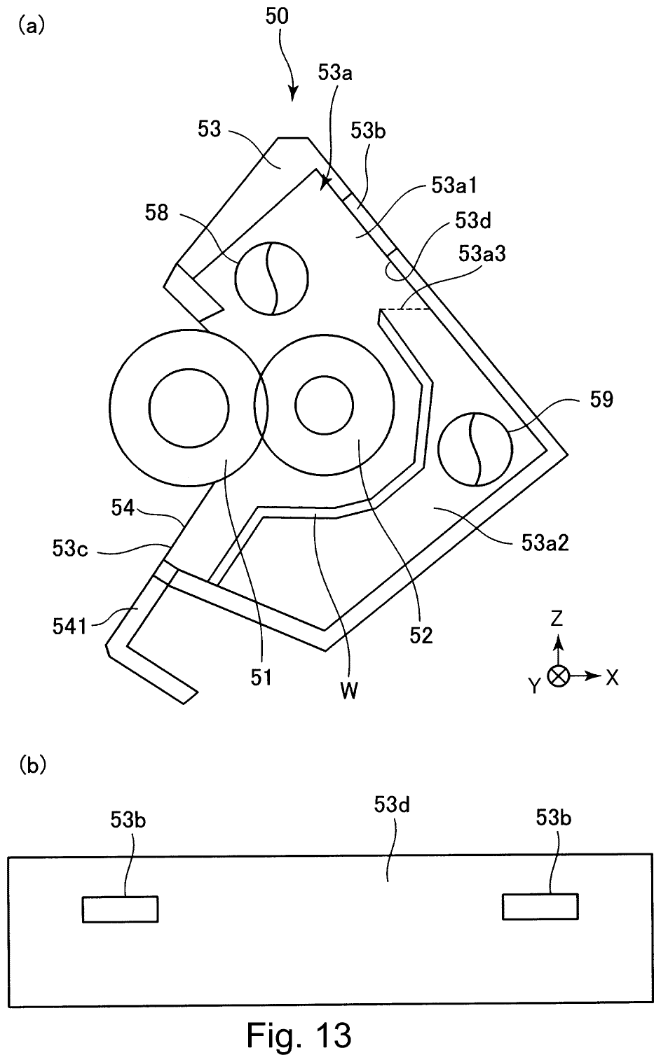

FIG. 10 is a schematic sectional view of a developing unit 50 in this embodiment. FIG. 10 shows a cross section substantially perpendicular to the rotational axis 51C of the developing roller 51 of the developing unit 50 in the developing position. Incidentally, in FIG. 10, the photosensitive drum 2 and a toner cartridge 70 are also shown. Further, in FIG. 10, the “new toner” is indicated by the white circle “◯”, and the “deteriorated toner” is indicated by the black circle “ [symbol] ”.

In this embodiment, a receiving opening 53b is provided in the second region 53a2 of the developing chamber 53a. Further, in this embodiment, in a position corresponding to this receiving opening 53b, a discharge opening 71b of the toner cartridge 70 is provided. That is, in the state in which the developing roller 51 is disposed in the developing position, with respect to the vertical direction, the receiving opening 53b and the discharge opening 71b are positioned below a horizontal line passing through the apex of the partition wall W. Thus, this embodiment is different from the embodiment 1 in that the receiving opening 53b is provided in a position where the new toner is directly supplied from the toner accommodating portion 71a to the second region 53a2.

In the constitution of the embodiment 1, when the new toner is supplied into the developing chamber 53a through the receiving opening 53b, as shown in FIG. 4, in the case where the surface of the toner in the first region 53a1 is present up to the position of the horizontal line H2 passing through the apex P1 of the partition wall W, the following phenomenon occurs. That is, the new toner is basically dropped into the second region 53a2 with the rotation of the rotary 90 and does not remain in the first region 53a1.

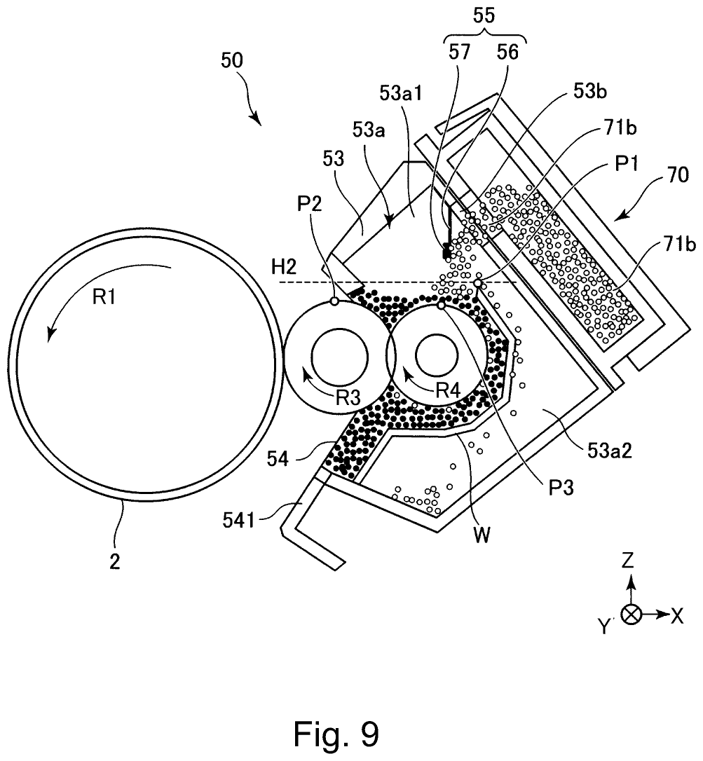

On the other hand, FIG. 9 is a schematic sectional view of the developing unit 50 in the embodiment 1 similar to the developing unit 50 as shown in FIG. 4, showing a state in which the position of the toner surface is different from the position of the toner surface in FIG. 4. As shown in FIG. 9, in the case where the surface of the toner in the first region 53a1 is below the position of the horizontal line H2 passing through the apex P1 of the partition wall W (i.e., is positioned on a side lower than the horizontal line H2), there is a possibility that the following phenomenon occurs. That is, the new toner remains in the first region 53a1 and is taken in the cells of the supplying roller 52 in the supplying portion downstream region V1 shown in FIG. 2.

Thereafter, the new toner is moved in the rotational direction (arrow R4 direction) of the supplying roller 52 and is discharged in the supplying portion upstream region V2 shown in FIG. 2, and in addition, is supplied to the developing roller 51. By this, there is a possibility that the supply fog occurs.

In this embodiment, the receiving opening 53b is provided in a position where the new toner is directly supplied from the toner accommodating portion 71a to the second region 53a2, so that the possibility that the supply fog occurs is reduced.

That is, by disposing the receiving opening 53b in such a position, as shown in FIG. 9, even in the case where the surface of the toner in the first region 53a1 is less than the position of the horizontal line H2, by a toner mixing mechanism described later, the supply fog can be suppressed.

### 2. Mechanism of Supplying Fog Suppression

Next, a mechanism (mechanism of toner mixing) of suppression of the supply fog in the developing unit 50 in this embodiment will be described. FIGS. 11 and 12 are schematic sectional views of a rotary developing device 91, similar to the rotary developing device 91 of FIGS. 7 and 8, for illustrating the mechanism of toner mixing in the developing unit 50 with rotation of the rotary 90.

Part (a) of FIG. 11 shows a state in which the rotary 90 takes the exchange attitude such that the toner cartridge 70 is electric chargeable and in which the illustrated single developing unit 50 is in the exchanging position where the toner cartridge 70 is exchangeable (detachably mountable). In the state of part (a) of FIG. 11, the non-return valve 55 is closed. As shown in part (a) of FIG. 11, when the rotary 90 takes the exchange attitude, the toner cartridge 70 corresponding to the developing unit 50 in the exchanging position is slid in an arrow S1 direction in part (a) of FIG. 11. By this, the toner cartridge 70 is demounted (detached) from the apparatus main assembly 1A (rotary 90). On the other hand, as shown in part (b) of FIG. 11, when the rotary 90 takes the exchange attitude, the toner cartridge 70 corresponding to the developing unit 50 in the exchanging position is slid in an arrow S2 direction in part (b) of FIG. 11. By this, the toner cartridge 70, typically, a new (brand-new) toner cartridge 70 is mounted to the apparatus main assembly 1A (rotary 90).

Part (c) of FIG. 11 shows a state in which the rotary 90 is rotated from the state of part (a) of FIG. 11 in the arrow R2 direction by about 45°. In the following, each of parts (d) to (g) of FIG. 11 and parts (a) to (h) of FIG. 12 also similar shows a state in which the rotary 90 is rotated from a previous state by about 45°.

In the state of part (c) of FIG. 11, the non-return valve 55 is closed, and therefore, movement of the new toner from the toner accommodating portion 71a into the developing frame 53 and movement of the toner in an opposite direction thereto do not occur.

In the state of part (d) of FIG. 11, the non-return valve 55 starts to open, so that the toner starts to move from the toner accommodating portion 71a to the developing frame 53.

In the state of part (e) of FIG. 11, the non-return valve opens, so that the new toner moves from the toner accommodating portion 71a to the second region 53a2. At this time, in this embodiment, the new toner is guided by the non-return valve 55 and enters the second region 53a2. Further, at this time, in this embodiment, the non-return valve 55 restricts movement of the new toner toward the first region 53a1. That is, in this embodiment, in the state of part (e) of FIG. 11 (and in a state of part (f) of FIG. 11 described later), a weight 57 of the non-return valve 55 at a free end of the non-return valve 55 is constituted so as to contact a side surface W1 (FIG. 9) of the partition wall W on a second region 53a2 side. Thus, in this embodiment, the non-return valve 55 also functions as a guiding member for guiding the movement of the new toner from the toner accommodating portion 71a to the second region 53a2 and a restricting member for restricting the movement of the new toner from the second region 53a2 toward the first region 53a1. Thus, in this embodiment, the toner moved from the toner cartridge 70 to the developing chamber 53a is directly movable to the second region 53a2 without passing through the first region 53a1.

In the state of part (f) of FIG. 11, the new toner further moves from the toner accommodating portion 71a to the second region 53a2.

In the state of part (g) of FIG. 11, the illustrated single developing unit 50 is in a state in which the rotary 90 in the developing position similar to the positions of FIG. 10 takes the development attitude. In this state, the developing roller 51 and the supplying roller 52 are rotated, so that the toner is supplied to the developing roller 51 and the image forming operation (developing operation) is performed.

In the state of part (g) of FIG. 11, the deteriorated toner positioned on an upper side in the vertical direction relative to the horizontal line H2 (see FIG. 4) passing through the apex P1 of the partition wall W is dropped from the first region 53a1 into the second region 53a2.

As a result, in the second region 53g2, the deteriorated toner and the new toner are mixed and rubbed with each other, so that the electric charge of the deteriorated toner from which the external additive is detached or in which the external additive is embedded is remarkably taken by the new toner on which the external additive is deposited in a large amount. Thus, by rotation of the rotary 90, the toner accommodated in the toner cartridge 70 and the toner accommodated in the first region 53a1 are moved to the second region 53a2 and are mixed with each other.

On the other hand, in the state of part (g) of FIG. 11, the new toner hardly exists in the first region 53a1, and therefore, it is possible to suppress that the supply fog occurs. Further, in the state of part (g) of FIG. 11, the non-return valve 55 opens, so that the new toner is further moved from the toner accommodating portion 71a to the second region 53a2.

In the state of part (a) of FIG. 12, the deteriorated toner is moved from the first region 53a1 to the second region 53a2. Further, the non-return valve is closed. Further, in the second region 53a2, the deteriorated toner remarkably losing the electric charge in the state of part (g) of FIG. 11 and normal deteriorated toner moved from the first region 53a1 to the second region 53a2 in the state of part (a) of FIG. 12 are mixed and rubbed with each other. By this, the toner remarkably losing the electric charge takes back the electric charge from the normal deteriorated toner, so that the electric charge is restored.

In the states of parts (b) to (e) of FIG. 12, from the second region 53a2 to the first region 53a1, the toner mixed in the second region 53a2 is returned, and in addition, is mixed. By this, the electric charge of the toner remarkably losing the electric charge is further restored.

In the state of parts (f) and (g) of FIG. 12, the toner is further mixed in the first region 53a1. By this, the electric charge of the toner remarkably losing the electric charge is further restored. Here, the non-return valve 55 starts to open in the state of part (e) of FIG. 12, and is open in the states of parts (f) and (g) of FIG. 12. For that reason, in the states of parts (f) and (g) of FIG. 12, the new toner is moved from the toner accommodating portion 71a to the second region 53a2.

The state of part (h) of FIG. 12 is a state in which the rotary 90 takes the development attitude after being rotated once from the state of part (g) of FIG. 11. In this state, the toner is supplied to the developing roller 51 by rotation of the developing roller 51 and the supplying roller 52, so that the image forming operation (developing operation) is performed. Here, as described above, in the first region 53a1, the toner is sufficiently mixed, and the electric charge is averages, so that the toner remarkably losing the electric charge hardly exists. Accordingly, it is possible to suppress that the supply fog as in the case of the developing unit 50 in the above-described comparison example occurs. Thus, in this embodiment, in the state in which the developing member 51 is disposed in the developing position, with respect to the vertical direction, the receiving opening 53b and the discharge opening 71b are positioned below the horizontal line passing through the apex of the partition wall W. Further, in this embodiment, the toner moved from the toner cartridge 70 to the developing chamber 53a can be directly moved to the second region 53a2 without passing through the first region 53a1. Further, in this embodiment, the guiding member 55 for guiding the movement of the toner from the toner cartridge 70 into the second region 53a2 is provided. In this embodiment, this guiding member 55 is constituted by the non-return valve for opening and closing the toner cartridge opening 53b with the rotation of the rotary 90.

As described above, in this embodiment, the receiving opening 53b is disposed in the second region 53a2. By this even in the case where the surface of the toner in the first region 53a1 becomes low, compared with the embodiment 1, it is possible to more stably suppress the occurrence of the supply fog.

### OTHER EMBODIMENTS

In the above, the present invention was described based on the specific embodiments, but the present invention is not limited to the above-described embodiments.

In the above-described embodiments, the development attitude of the rotary was the attitudes shown in part (g) of FIG. 7 and part (g) of FIG. 11. However, the present invention is not limited thereto, but even when the development attitude of the rotary is another attitude, similarly, the toner mixing mechanism sufficiently acts before the toner is supplied onto the developer carrying member (developing roller).

Further, in the above-described embodiments, the developing unit was provided with the non-return valve. However, the present invention is not limited thereto, but even in a constitution in which the non-return valve is not provided similarly, the toner mixing mechanism sufficiently acts before the toner is supplied to the developer carrying member (developing roller).

Further, in the above-described embodiments, the developer carrying member (developing roller) and the supplying member (supplying roller) were provided in the first region. However, the present invention is not limited thereto, but even in a constitution in which the supplying member (supplying roller) is not provided in the first region, similarly, the toner mixing mechanism sufficiently acts before the toner is supplied to the developer carrying member (developing roller).

Further, in the above-described embodiments, the movement of the toner in the developing chamber by the rotation of the rotary was described, but a conveying member (which may also have a function as a stirring member for stirring the toner) for conveying the toner may be provided in the developing chamber. Part (a) of FIG. 13 is a schematic sectional view of a developing unit 50, showing an example in which the conveying member is provided in the developing chamber 53a, and part (b) of FIG. 13 is a schematic front view of an inner wall surface 53d of the developing chamber. For example, as showing in part (b) of FIG. 13, receiving openings 53b are provided in localized positions such as positions close to opposite end portions with respect to a longitudinal direction of the developing chamber 53a in some instances. For example, in such a case, in order to uniformize the toner with respect to the longitudinal direction of the developing chamber 53a or the like, it is possible that a conveying member 58 is provided in the first region 53a1 and a conveying member 59 is provided in the second region 53a2. As regards these members, either one of these members may be provided, or both of these members may be provided. As the conveying member, for example, it is possible to cite a screw, an anger. Further, for example, a member including a rotatable shaft member and a sheet-like conveying portion (stirring portion) mounted to this shaft member, or the like member may be used.

According to the present invention, in a constitution in which to a rotatable rotary provided a plurality of developing chambers, a toner cartridge in which toner to be supplied to an associated one of the developing chambers is detachably mountable, it is possible to suppress that the supplying fog occurs.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-070172 filed on Apr. 23, 2024, which is hereby incorporated by reference herein in its entirety.

What is claimed is:

1. An image forming apparatus comprising:
an image bearing member on which an electrostatic image is formed;
a rotary including a developing chamber for accommodating toner and a developing member for developing the electrostatic image by supplying the toner accommodated in the developing chamber to the image bearing member and rotatable so as to move the developing member to a developing position where the developing member supplies the toner to the image bearing member; and
a toner cartridge configured to accommodate the toner supplied to the developing chamber and detachably mounted to the rotary,
wherein the developing chamber includes a partition wall for partitioning the developing chamber into a first region including the developing member and a second region,
wherein the toner is supplied from the toner cartridge to the developing chamber by communication between a receiving opening provided in the developing chamber and a discharge opening provided in the toner cartridge; and
wherein the toner accommodated in the toner cartridge and the toner accommodated in the first region are moved to the second region by rotation of the rotary and then are mixed in the second region.

2. An image forming apparatus according to claim 1, wherein in a case where the developing member is in the developing position, with respect to a vertical direction, the receiving opening and the discharge opening are positioned above a horizontal line passing through an uppermost end of the partition wall.

3. An image forming apparatus according to claim 2, wherein the toner moved from the toner cartridge to the developing chamber is suppressed from remaining in the first region by the toner moved from the second region to the first region and is moved to the second region.

4. An image forming apparatus according to claim 1, wherein in a case where the developing member is in the developing position, with respect to a vertical direction, the receiving opening and the discharge opening are positioned below a horizontal line passing through an uppermost end of the partition wall.

5. An image forming apparatus according to claim 4, wherein the toner moved from the toner cartridge to the developing chamber is movable to the second region without passing through the first region.

6. An image forming apparatus according to claim 4, wherein the developing chamber includes a guiding member for guiding movement of the toner from the toner cartridge to the second region.

7. An image forming apparatus according to claim 6, wherein the guiding member is a non-return valve for opening and closing the receiving opening with rotation of the rotary.

8. An image forming apparatus according to claim 1, wherein in a case where the developing member is in the developing position, with respect to a vertical direction, an uppermost end of the partition wall is positioned above an uppermost end of the developing member.

9. An image forming apparatus according to claim 1, wherein the rotary includes a supplying member,
wherein in a case where the developing member is disposed in the developing position, the supplying member supplies, to the developing member, the toner accommodated in the first region.

10. An image forming apparatus according to claim 9, wherein in a state in which the developing member is disposed in the developing position, with respect to a vertical direction, an uppermost end of the partition wall is positioned above an uppermost end of the developing member and an uppermost end of the supplying member.

11. An image forming apparatus according to claim 1, wherein the rotary includes a conveying member for conveying the toner accommodated in the developing chamber.
